(19) United States
(12) Patent Application Publication
(10) Pub. No.: US 2024/0155479 A1
(43) Pub. Date: May 9, 2024

(54) METHOD AND DEVICE FOR PROVIDING NETWORK SLICE WITH FINE GRANULARITY IN WIRELESS COMMUNICATION SYSTEM

(71) Applicant: SAMSUNG ELECTRONICS CO., LTD., Suwon-si (KR)

(72) Inventor: Dongeun SUH, Suwon-si (KR)

(21) Appl. No.: 18/499,997

(22) Filed: Nov. 1, 2023

(30) Foreign Application Priority Data
Nov. 3, 2022 (KR) 10-2022-0145285

(51) Int. Cl. H04W 48/18; H04W 60/04

(52) U.S. Cl. CPC H04W 48/18; H04W 60/04

(57) ABSTRACT

The present disclosure relates to a 5G or 6G communication system for supporting a higher data transmission rate. The present disclosure provides a method for providing subdivided network slices in a wireless communication system. A method for operating a user equipment (UE) according to an embodiment may comprise transmitting, to an access and mobility management function (AMF), a registration request message including a request slice (requested NSSAI) and a per-cell slice service area support indicator (CSSA support indication) and receiving, from the AMF, a registration accept message including service area information per-allowed slice (slice area per allowed NSSAI) about the UE determined based on the request slice and the per-cell slice service area support indicator.

### CROSS-REFERENCE TO RELATED APPLICATION

This application is based on and claims priority under 35 U.S.C. § 119 to Korean Patent Application No. 10-2022-0145285, which was filed in the Korean Intellectual Property Office on Nov. 3, 2022, the entire disclosure of which is incorporated herein by reference.

### TECHNICAL FIELD

The present disclosure provides a method for providing a network slice with fine granularity in a wireless communication system.

### DESCRIPTION OF RELATED ART

5G mobile communication technology defines a wide frequency band to enable fast transmission speed and new services and may be implemented in frequencies below 6 GHz (‘sub 6 GHz’), such as 3.5 GHz, as well as in ultra-high frequency bands (‘above 6 GHz’), such as 28 GHz and 39 GHz called millimeter wave (mmWave). Further, 6G mobile communication technology, which is called a beyond 5G system, is considered to be implemented in terahertz bands (e.g., 95 GHz to 3 THz) to achieve a transmission speed 50 times faster than 5G mobile communication technology and ultra-low latency reduced by 1/10.

In the early stage of 5G mobile communication technology, standardization was conducted on beamforming and massive MIMO for mitigating propagation pathloss and increasing propagation distance in ultrahigh frequency bands, support for various numerologies for efficient use of ultrahigh frequency resources (e.g., operation of multiple subcarrier gaps), dynamic operation of slot format, initial access technology for supporting multi-beam transmission and broadband, definition and operation of bandwidth part (BWP), new channel coding, such as low density parity check (LDPC) code for massive data transmission and polar code for high-reliable transmission of control information, L2 pre-processing, and network slicing for providing a dedicated network specified for a specific service, so as to meet performance requirements and support services for enhanced mobile broadband (eMBB), ultra-reliable low-latency communications (URLLC), and massive machine-type communications (mMTC).

Currently, improvement and performance enhancement in the initial 5G mobile communication technology is being discussed considering the services that 5G mobile communication technology has intended to support, and physical layer standardization is underway for technology, such as vehicle-to-everything (V2X) for increasing user convenience and assisting autonomous vehicles in driving decisions based on the position and state information transmitted from the VoNR, new radio unlicensed (NR-U) aiming at the system operation matching various regulatory requirements, NR UE power saving, non-terrestrial network (NTN) which is direct communication between UE and satellite to secure coverage in areas where communications with a terrestrial network is impossible, and positioning technology.

Also being standardized are radio interface architecture/protocols for technology of industrial Internet of things (IIoT) for supporting new services through association and fusion with other industries, integrated access and backhaul (IAB) for providing nodes for extending the network service area by supporting an access link with the radio backhaul link, mobility enhancement including conditional handover and dual active protocol stack (DAPS) handover, 2-step random access (RACH for NR) to simplify the random access process, as well as system architecture/service fields for 5G baseline architecture (e.g., service based architecture or service based interface) for combining network functions virtualization (NFV) and software-defined networking (SDN) technology and mobile edge computing (MEC) for receiving services based on the position of the UE.

As 5G mobile communication systems are commercialized, soaring connected devices would be connected to communication networks so that reinforcement of the function and performance of the 5G mobile communication system and integrated operation of connected devices are expected to be needed. To that end, new research is to be conducted on, e.g., extended reality (XR) for efficiently supporting, e.g., augmented reality (AR), virtual reality (VR), and mixed reality (MR), and 5G performance enhancement and complexity reduction using artificial intelligence (AI) and machine learning (ML), support for AI services, support for metaverse services, and drone communications.

Further, development of such 5G mobile communication systems may be a basis for multi-antenna transmission technology, such as new waveform for ensuring coverage in 6G mobile communication terahertz bands, full dimensional MIMO (FD-MIMO), array antenna, and large scale antenna, full duplex technology for enhancing the system network and frequency efficiency of 6G mobile communication technology as well as reconfigurable intelligent surface (RIS), high-dimensional space multiplexing using orbital angular momentum (OAM), metamaterial-based lens and antennas to enhance the coverage of terahertz band signals, AI-based communication technology for realizing system optimization by embedding end-to-end AI supporting function and using satellite and artificial intelligence (AI) from the step of design, and next-generation distributed computing technology for implementing services with complexity beyond the limit of the UE operation capability by way of ultrahigh performance communication and computing resources.

### SUMMARY

Network slices may be provided for some or all of the areas served by the network operator. The unit of the area where the network slice is provided (i.e., network slice service area) may be the tracking area (TA) which is a unit representing one or more base stations and may be used by the network operator to determine the location of the UE.

When providing network slices on a per-TA basis, it may be difficult to provide network slices for areas (e.g., slices provided only to a specific base station) subdivided than the TA. The present disclosure aims to provide network slices in units (e.g., cells) smaller than the TA.

The present disclosure provides a UE-based method and a network-based method for providing network slices in the units of cells.

In the UE-based method for providing network slices in the units of cells, the UE may determine whether the UE is located in or outside a slice service area based on its own location information and information received from the network and operate according to the result of the determination (e.g., releasing the session).

In the network-based method for providing network slices in the units of cells, the network may grasp the location of the UE, determine whether the UE moves outside the network slice service area, and operate according to the result of the determination (e.g., releasing the session).

A method for operating a user equipment (UE) in a wireless communication system according to an embodiment may comprise transmitting, to an access and mobility management function (AMF), a registration request message including a request slice (requested NSSAI) and a per-cell slice service area support indicator (CSSA support indication) and receiving, from the AMF, a registration accept message including service area information per-allowed slice (slice area per allowed NSSAI) about the UE determined based on the request slice and the per-cell slice service area support indicator.

A method for operating an access and mobility management function (AMF) in a wireless communication system according to an embodiment may comprise receiving, from a user equipment (UE), a registration request message including a request slice (requested NSSAI) and a per-cell slice service area support indicator (CSSA support indication) and transmitting, to the UE, a registration accept message including service area information per-allowed slice (slice area per allowed NSSAI) about the UE determined based on the request slice and the per-cell slice service area support indicator.

A user equipment (UE) in a wireless communication system according to an embodiment comprises a transceiver and a controller connected to the transceiver. The controller may control to transmit, to an access and mobility management function (AMF), a registration request message including a request slice (requested NSSAI) and a per-cell slice service area support indicator (CSSA support indication). The controller may receive, from the AMF, a registration accept message including service area information per-allowed slice (slice area per allowed NSSAI) about the UE determined based on the request slice and the per-cell slice service area support indicator.

An access and mobility management function (AMF) in a wireless communication system according to an embodiment comprises a transceiver and a controller connected to the transceiver. The controller may receive, from a user equipment (UE), a registration request message including a request slice (requested NSSAI) and a per-cell slice service area support indicator (CSSA support indication). The controller may control to transmit, to the UE, a registration accept message including service area information per-allowed slice (slice area per allowed NSSAI) about the UE determined based on the request slice and the per-cell slice service area support indicator.

Through the method for providing network slices in the units of cells provided in the present disclosure, the network operator may provide a network slice service in subdivided areas.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 illustrates a 5G system architecture according to embodiments of the present disclosure;

FIG. 2 illustrates a method in which an NSSF gathers supported slice(s) per cell information from a RAN through an AMF according to embodiments of the present disclosure;

FIG. 3 illustrates a method for providing an area allowed per cell for each S-NS SAI in a UE registration procedure according to embodiments of the present disclosure;

FIG. 4 illustrates a method for providing a slice area per S-NSSAI through a URSP rule in a registration procedure according to embodiments of the present disclosure;

FIG. 5 illustrates a network-based cell level slice service area supporting method through a UE configuration update procedure according to an embodiments of the present disclosure;

FIG. 6 illustrates a UE according to embodiments of the present disclosure; and

FIG. 7 illustrates a network device according to embodiments of the present disclosure.

### DETAILED DESCRIPTION

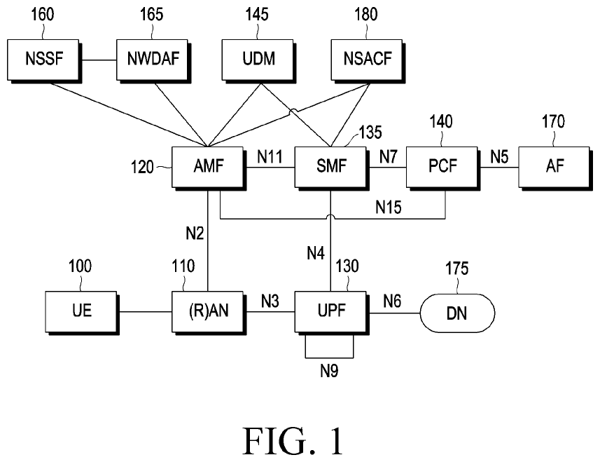

FIGS. 1 through 7, discussed below, and the various embodiments used to describe the principles of the present disclosure in this patent document are by way of illustration only and should not be construed in any way to limit the scope of the present disclosure. Those skilled in the art will understand that the principles of the present disclosure may be implemented in any suitably arranged system or device.

Hereinafter, embodiments of the present disclosure are described in detail with reference to the accompanying drawings. In describing embodiments, the description of technologies that are known in the art and are not directly related to the present disclosure is omitted. This is for further clarifying the gist of the present disclosure without making it unclear.

For the same reasons, some elements may be exaggerated or schematically shown. The size of each element does not necessarily reflect the real size of the element. The same reference numeral is used to refer to the same element throughout the drawings.

Advantages and features of the present disclosure, and methods for achieving the same may be understood through the embodiments to be described below taken in conjunction with the accompanying drawings. However, the present disclosure is not limited to the embodiments disclosed herein, and various changes may be made thereto. The embodiments disclosed herein are provided only to inform one of ordinary skilled in the art of the category of the present disclosure. The present disclosure is defined only by the appended claims. The same reference numeral denotes the same element throughout the specification.

It should be appreciated that the blocks in each flowchart and combinations of the flowcharts may be performed by computer program instructions.

Further, each block may represent a module, segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions.

As used herein, the term “unit” means a software element or a hardware element such as a field-programmable gate array (FPGA) or an application specific integrated circuit (ASIC). A unit plays a certain role. However, a “unit” is not limited to software or hardware. A “unit” may be configured in a storage medium that may be addressed or may be configured to execute one or more processors. Accordingly, as an example, a “unit” includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the “units” may be combined into smaller numbers of components and “units” or further separated into additional components and “units.” Further, the components and “units” may be implemented to execute one or more CPUs in a device or secure multimedia card. According to embodiments, a “ . . . unit” may include one or more processors.

As used herein, terms for identifying access nodes, terms denoting network entities, terms denoting messages, terms denoting inter-network entity interfaces, and terms denoting various pieces of identification information are provided as an example for ease of description. Thus, the present disclosure is not limited to the terms, and the terms may be replaced with other terms denoting objects with equivalent technical meanings.

FIG. 1 illustrates a 5G system architecture according to embodiments of the present disclosure.

Referring to FIG. 1, a 5G mobile communication network includes a 5G user equipment (UE, also referred to as a terminal) 100, a 5G radio access network (RAN, also referred to as a base station) 110, a 5g nodeB (gNB) 110, an evolved nodeB (eNB) 110, and a 5G core network 120 to 180.

The 5G core network 120 to 180 may include at least one of an access and mobility management function (AMF) 120 that provides a mobility management function for the UE, a session management function (SMF) 135 that provides a session management function, a user plane function (UPF) 130 that performs a data transfer function, a policy control function (PCF) 140 that provides a policy control function, a unified data management (UDM) 145 that provides a data management function, such as subscriber data and policy control data, a network slicing selection function (NSSF) 160 that provides a network slice selection function, a network data analytics function (NWDAF) 165 that provides a network data analytics function, an application function (AF) 170, a data network (DN) 175, and a network slice access control function (NSACF) 180. The 5G core network 120 to 180 may further include NFs, such as unified data repository (UDR), for storing data of various network functions (NFs).

In the 3GPP system, a conceptual link connecting NFs in the 5G system is defined as a reference point. Example reference points included in the 5G system architecture represented in FIG. 1 are provided as follows:
N1: the reference point between the UE and the AMF;
N2: Reference point between (R)AN and AMY;
N3: Reference point between (R)AN and UPF;
N4: Reference point between SMF and UPF;
N5: Reference point between PCF and AF;
N6: Reference point between UPF and DN;
N7: Reference point between SMF and PCF;
N8: the reference point between the UDM and the AMF;
N9: Reference point between two core UPFs;
N10: Reference point between UDM and SMF;
N11: Reference point between AMF and SMF;
N12: Reference point between AMF and AUSF;
N13: the reference point between UDM and authentication server function (AUSF);
N14: the reference point between two AMFs; and/or
N15: the reference point between PCF and AMF in non-roaming scenario and reference point between PCF in visited network and AMF in roaming scenario.

In the 5G system, network slicing is a technique and structure that enables several virtualized, independent, logical networks in one physical network. The network operator configures a virtual end-to-end network called a network slice and provides service to meet specified requirements for the service/application. In this case, the network slice is identified by an identifier called single-network slice selection assistance information (S-NSSAI). The network transmits a set of allowed slices (e.g., allowed NSSAI(s)) to the UE in a UE registration procedure, and the UE may transmit/receive application data through the protocol data unit (PDU) session generated through one S-NSSAI (i.e., network slice) among the allowed NSSAI(s).

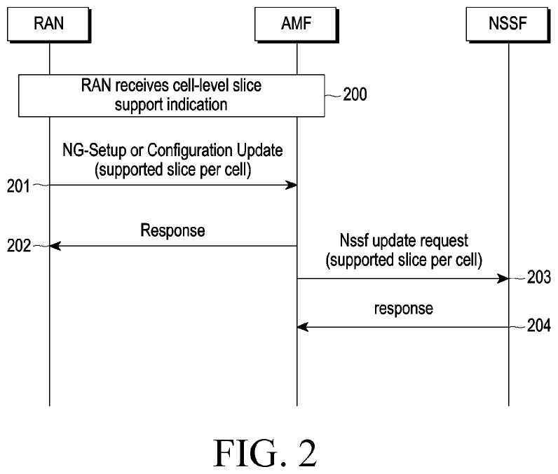

FIG. 2 illustrates a method in which an NSSF gathers supported slice(s) per cell information from a RAN through an AMF according to embodiments of the present disclosure. The RAN, the AMF, and the NSSF illustrated in FIG. 2 may be the RAN 110 of FIG. 1, the AMF 120 of FIG. 1, and the NSSF 160 of FIG. 1, respectively.

In operation 200, the RAN may receive whether the AMF supports slices in the units of cells from the AMF and/or operations, administration and maintenance (OAM) (not shown). Whether to support slices in the units of cells may be included and provided in an NG setup message or configuration update message transmitted to the RAN by the AMF.

In operation 201, the RAN may transmit the NG setup request message (or the configuration update message) including at least one of a PLMN id, a tracking area code (TAC), and a list of supported slices per cell to the AMF. According to an embodiment, the list of supported slices per cell may be provided only when the AMF supports network slices in the units of cells. According to an embodiment, the list of supported slices per cell may be configured as a set of supported list of slices and cell id. Operation 201 may be performed by multiple RANs connected to the AMF.

In operation 202, the AMF may transmit a response message to the NG setup request message (or configuration update message) transmitted in operation 201 to the RAN.

In operation 203, the AMF may identify list of slices per cell information based on the information received in operation 201 and may transmit an Nssf update request message including the list of slices per cell information to the NSSF. According to an embodiment, when there is a plurality of AMFs, the AMFs may transmit the list of slices per cell information received from the RAN(s) to the NSSF.

In operation 204, the NSSF may transmit a response message to the Nssf update request message transmitted in operation 203 to the AMF.

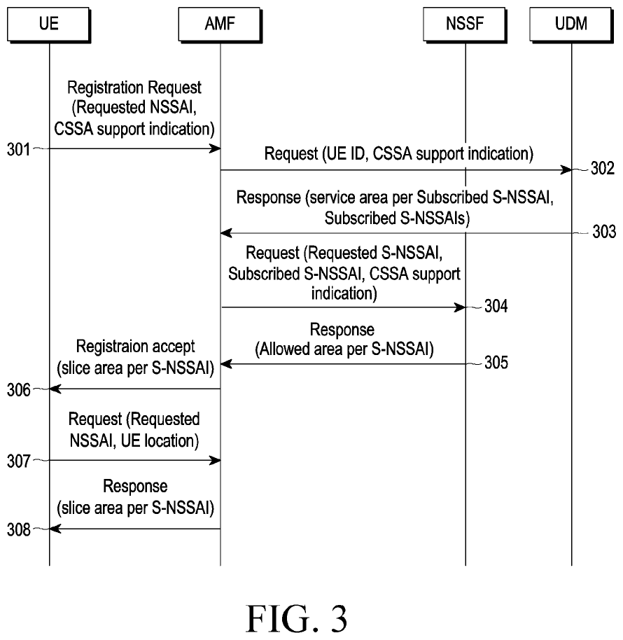

FIG. 3 illustrates a method for providing an area allowed per cell for each S-NSSAI in a UE registration procedure according to embodiments of the present disclosure. The UE, the AMF, the NSSF, and the UDM illustrated in FIG. 3 may be the UE 100 of FIG. 1, the AMF 120 of FIG. 1, the NSSF 160 of FIG. 1, and the UDM 145 of FIG. 1, respectively.

In operation 301, the UE may transmit a registration request message to the AMF. According to an embodiment, the registration request message may include a request slice (i.e., a requested NSSAI) and a cell-level slice service area (CSSA) indication (i.e., a per-cell slice service area support indicator).

According to an embodiment, an allowed slice of the UE and an allowed area (i.e., a slice service area) per allowed slice may be provided to the UE by the UDM in the form of subscription information about the UE or may be provided to the UE by the NSSF. When the UDM provides information about the allowed slice of the UE and the allowed area per allowed slice, operations 302 and 303 may be performed, and when the NSSF provides information about the allowed slice of the UE and the allowed area per allowed slice, operations 304 and 305 may be performed.

In operation 302, the UE may transmit a request message for requesting subscription information about the UE to the UDM. According to an embodiment, the request message may include a UE ID (e.g., SUPI) and the CSSA support indication received in operation 301.

In operation 303, the UDM may transmit, to the AMF, a response message including subscription information corresponding to the UE ID received in operation 302. According to an embodiment, the response message may include a subscribed S-NSSAI (s) (i.e., identifier information about network slices to which the UE subscribes). According to an embodiment, when the CSSA support indication is included in the message received by the AMF in operation 301, the response message may include a service area per subscribed S-NSSAI (service area for each subscribed slice). According to an embodiment, the service area per subscribed S-NSSAI may be configured in the form of a list of cell id (i.e., a list composed of cell identifiers) or a list of TA IDs (a list composed of TA identifiers). According to an embodiment, the service area per subscribed S-NSSAI may be provided in a form included in the subscribed S-NSSAI(s) or may be provided in a separate form.

In operation 304, the AMF may transmit a request message for requesting the allowed slice of the UE to the NSSF. According to an embodiment, the request message may include at least one of the requested NSSAI, CSSA support indication information, and subscribed S-NSSAIs (i.e., subscribed slice information about the UE obtained from the UDM) received in operation 301.

In operation 305, the NSSF may identify (or calculate) the allowed slice of the UE and the allowed area (slice service area per S-NSSAI), based on the information received in operation 304, and may transmit a response message including the allowed area per S-NSSAI to the AMF.

In operation 306, the AMF may transmit, to the UE, a registration accept message including the allowed area per S-NSSAI determined based on the information received in operation 303 or 305. According to an embodiment, the AMF may calculate a set of allowed slices to be transmitted to the UE and service area information (slice area per allowed NSSAI) per allowed slice to be transmitted to the UE, based on the information received in operation 303 or 305 and the current location information about the UE. According to an embodiment, when the same service area information is determined for two or more slices, only one piece of service area information may be provided for the corresponding slices. According to an embodiment, separate service area information may be provided when the service area information differs for each slice.

In operation 307, when the UE moves out of the allowed service received in operation 306 for the arbitrary allowed slice (when the current cell of the UE or the TA is not included in the service area of the corresponding slice received in operation 306), the UE may transmit a request message including the allowed slice, the allowed slice area, and the rejected slice information to the AMF. According to an embodiment, the UE may transmit a request message including the requested NSSAI and the location information about the UE to the AMF.

In operation 308, the AMF may transmit a response message including the slice area per S-NSSAI to the UE based on the information received from the UE in operation 307.

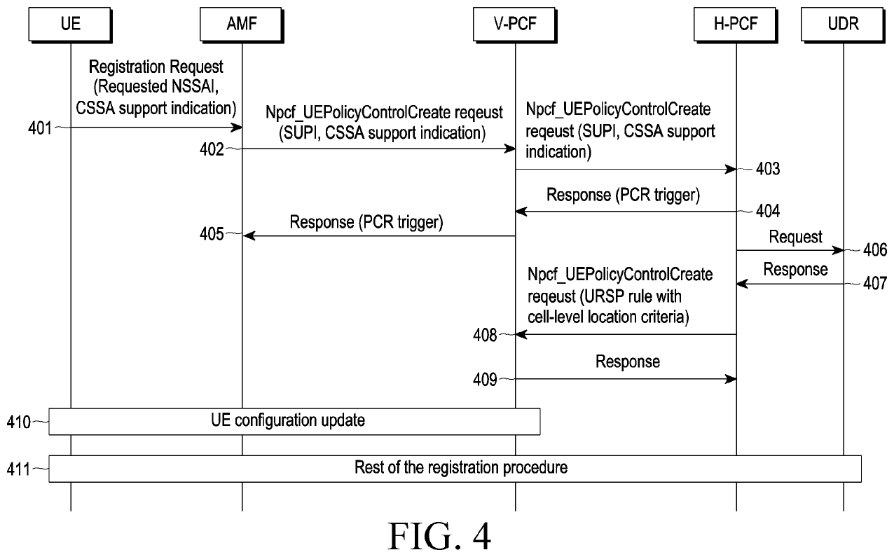

FIG. 4 illustrates a method for providing a slice area per S-NSSAI through a URSP rule in a registration procedure according to embodiments of the present disclosure. FIG. 4 illustrates a case in which each of the V-PCF and the H-PCF operates when the UE is roaming, but when the UE is not roaming, the V-PCF and the H-PCF may operate as one PCF, and operations between the V-PCF and the H-PCF may be omitted.

In operation 401, the UE may transmit a registration request message to the AMF. According to an embodiment, the registration request message may include a request slice (i.e., a requested NSSAI) and a cell-level slice service area (CSSA) support indication (i.e., a per-cell slice service area support indicator).

In operation 402, the AMF may transmit a UE policy control create request (Npcf_UEPolicyControlCreate request) to the V-PCF. According to an embodiment, the message (Npcf_UEPolicyControlCreate request) may include a UE ID (e.g., a subscription permanent identifier (SUPI)) and the CSSA support indication received in operation 401.

In operation 403, the V-PCF may transmit a UE policy control message including information included in the message (Npcf_UEPolicyControlCreate request) received in operation 402 to the H-PCF.

In operation 404, the H-PCF may transmit a response message including policy control request (PCR) trigger information to the V-PCF to receive information necessary to provide the URSP rule including the slice service area of the cell-level.

In operation 405, the V-PCF may transmit a response message including information included in the message received in operation 404 to the AMF. According to an embodiment, when the PCR trigger is included in the received message, the AMF may operate according to a condition met within the PCR trigger (e.g., when the location of the UE is changed, the V-PCF is notified of the location of the UE).

In operation 406, the H-PCF may request UE policy-related subscription information from the UDR. According to an embodiment, the request message may include a UE ID. According to an embodiment, when the CSSA support indication is received in operation 403, the H-PCF may include the CSSA support indication in the request message.

In operation 407, the UDR may include UE policy-related subscription information corresponding to the UE ID of the message received in operation 406 in the response message transmitted to the H-PCF. According to an embodiment, the UE policy-related subscription information may include subscribed S-NSSAIs and slice service area per subscribed S-NSSAI. According to an embodiment, the slice service area per subscribed S-NSSAI may be provided only when the CS SA support indication is included in the message received in operation 406.

In operation 408, the H-PCF may generate a URSP rule, include the URSP rule in the UE policy container, and transmit the Npcf_UEPolicyControlCreate request message to the V-PCF. According to an embodiment, each URSP rule may include at least one of a precedence value, a traffic descriptor (TD), a route selection descriptor (RSD), and a route selection validation criterion.

According to an embodiment, the UE may search for a URSP rule (a URSP rule having a highest precedence value when there is a plurality of URSP rules) having a traffic descriptor matching the application traffic, and then transmit the corresponding application traffic through the PDU session corresponding to the RSD included in the corresponding URSP rule. According to an embodiment, when the corresponding URSP rule includes route selection validation criteria and the route selection validation criteria includes location information about the UE where the corresponding URSP rule is allowed, the UE may compare the current location with the allowed UE location information in the route selection validation criteria, and when the UE is not currently in the allowed UE location, the UE may not use the corresponding URSP rule.

According to an embodiment, when the H-PCF receives the CSSA support indication in operation 403, the H-PCF may determine an allowed service area (i.e., slice service area per S-NSSAI) per S-NSSAI according to the operator policy or based on the information received from the UDR in operation 407. According to an embodiment, the H-PCF may generate URSP rules with cell-level location criteria which reflect the determined slice service area per S-NSSAI. According to an embodiment, when the URSP rule includes the S-NSSAI in the RSD, allowed UE location information in the route selection validation criteria of the corresponding URSP rule may be determined based on the service area for the corresponding S-NSSAI. According to an embodiment, the allowed UE location information may be configured in the form of a list of cell id or a list of TA id or may be configured in a combination of a list of cell id and a list of TA id.

In operation 409, the V-PCF may transmit a response message to the message received in operation 408 to the H-PCF.

In operation 410, the V-PCF may transmit the UE container including the URSP rule with cell-level location criteria received in operation 408 to the UE through the AMF. According to an embodiment, when there are URSP rules having route selection validation criteria including a list of cell id in the received URSP rule, the UE may determine that only the URSP rules including the id of the cell where the UE is currently located in the route selection validation criteria and use the same. According to an embodiment, when there are URSP rules having route selection validation criteria including a list of TA id in the received URSP rule, the UE may determine that only the URSP rules including the id of the TA where the UE is currently located in the route selection validation criteria are valid and use the same.

In operation 411, the remaining registration procedure may be performed.

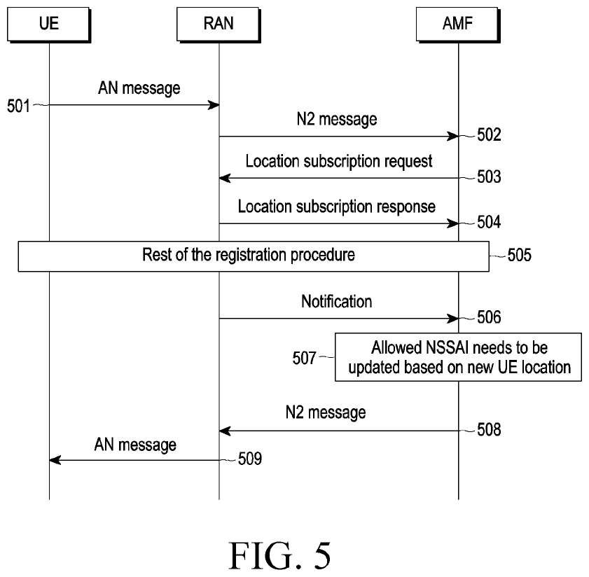

FIG. 5 illustrates a network-based cell level slice service area supporting method through a UE configuration update procedure according to embodiments of the present disclosure.

In operation 501, the UE may transmit a registration request message (AN message) to the RAN.

In operation 502, the RAN may transfer the registration request message received in operation 501 to the AMF (N2 message).

In operation 503, when there is a slice corresponding to the cell-level slice service area among the request slices included in the message requested by the UE in operation 501, the AMF may transmit a request message (a location subscription request) for requesting the RAN to provide a notification about the location change of the UE. According to an embodiment, the request message may include at least one of allowed slice information, per-slice service area information (list of cell id type), or UE id.

In operation 504, the RAN may transmit a response message (location subscription response) to the AMF.

In operation 505, the remaining UE registration procedure may be performed.

In operation 506, the RAN may identify whether the current location of the UE is included in the service area per slice for all slices received in operation 503. According to an embodiment, when there is a service area that does not include the current UE location, the RAN may include information indicating that the S-NSSAI and the UE are located outside the service area, in a message transmitted to the AMF.

When the message received in operation 503 includes information for periodically requesting to notify of the location (e.g., cell id) of the UE, the RAN may periodically provide the location information about the UE to the AMF.

In operation 507, when the message received in operation 506 includes information indicating that the UE is located outside the service area, or when there is a slice having a service area that does not correspond to the location of the UE included in the message received in operation 506, the AMF may exclude the corresponding slice from slices allowed to the UE (allowed NSSAIs). The excluded slice may be included in the rejected NSSAIs. In operation 507, the AMF may update the slices allowed to the UE (allowed NSSAIs) based on new location information about the UE, if necessary.

In operation 508, the AMF may include the allowed NSSAI determined in operation 507 in the UE configuration update command message in the message N2 transmitted to the RAN.

In operation 509, the RAN may transfer the message received in operation 508 to the UE.

According to an embodiment, when the UE configuration update command message includes the allocated NSSAI, the UE may delete the existing allocated NSSAI and store the received allocated NSSAI. According to an embodiment, when there is a PDU session for a slice that does not correspond to slices included in the received allow NSSAI, the UE may internally delete (local release) all information about the corresponding PDU session or transmit a NAS message for releasing the corresponding PDU session to the AMF.

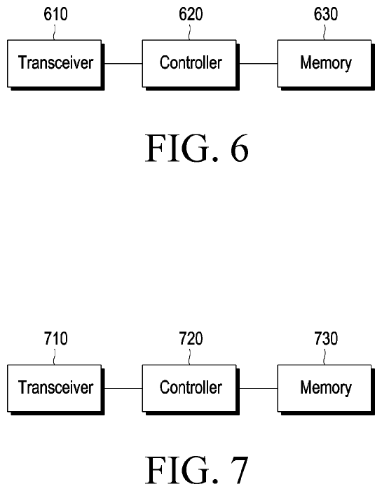

FIG. 6 illustrates a UE according to embodiments of the present disclosure.

As shown in FIG. 6, a UE of the present disclosure may include a transceiver 610, memory 620, and a processor 630. The processor 630, transceiver 610, and memory 620 of the UE may operate according to the above-described communication methods by the UE. However, the components of the UE are not limited thereto. For example, the UE may include more or fewer components than the above-described components. The processor 630, the transceiver 610, and the memory 620 may be implemented in the form of a single chip.

The transceiver 610 collectively refers to the transmitter of the UE and the receiver of the UE and may transmit and receive signals to/from the base station or network entity. The signals transmitted/received with the base station may include control information and data. To that end, the transceiver 610 may include a radio frequency (RF) transmitter for frequency-up converting and amplifying signals transmitted and an RF receiver for low-noise amplifying signals received and frequency-down converting the frequency of the received signals. However, this is merely an example of the transceiver 610, and the components of the transceiver 610 are not limited to the RF transmitter and the RF receiver.

Further, the transceiver 610 may include a wired/wireless transceiver and may include various components for transmitting/receiving signals.

The transceiver 610 may receive signals via a radio channel, output the signals to the processor 630, and transmit signals output from the processor 630 via a radio channel.

Further, the transceiver 610 may receive the communication signal and output the communication signal to the processor and transmit the signal output from the processor to the network entity through the wired/wireless network.

The memory 620 may store programs and data necessary for the operation of the UE. The memory 620 may store control information or data that is included in the signal obtained by the UE. The memory 620 may include a storage medium, such as ROM, RAM, hard disk, CD-ROM, and DVD, or a combination of storage media.

The processor 630 may control a series of processes for the UE to be able to operate according to the above-described embodiments. The processor 630 may include at least one processor. For example, the processor 630 may include a communication processor (CP) that performs control for communication and an application processor (AP) that controls an upper layer, such as an application program.

FIG. 7 illustrates a network device according to embodiments of the present disclosure. The network device shown in FIG. 7 may be any one of the RAN (or base station), AMF, NSSF, UDM, PCF, V-PCF, H-PCF, and UDR shown in FIGS. 2 to 5.

As shown in FIG. 7, a network device of the present disclosure may include a transceiver 710, memory 720, and a processor 730. The processor 730, transceiver 710, and memory 720 of the network device may be operated according to the above-described network device communication method. However, the components of the network entity are not limited thereto. For example, the network entity may include more or fewer components than the above-described components. The processor 730, the transceiver 710, and the memory 720 may be implemented in the form of a single chip.

The transceiver 710 collectively refers to the receiver of the network entity and the transmitter of the network entity and may transmit and receive signals to/from a UE or another network entity. In this case, the signals transmitted/received with the base station may include control information and data. To that end, the transceiver 710 may include a radio frequency (RF) transmitter for frequency-up converting and amplifying signals transmitted and an RF receiver for low-noise amplifying signals received and frequency-down converting the frequency of the received signals. However, this is merely an example of the transceiver 710, and the components of the transceiver 710 are not limited to the RF transmitter and the RF receiver. The transceiver 710 may include a wired/wireless transceiver and may include various components for transmitting/receiving signals.

Further, the transceiver 710 may receive signals via a communication channel (e.g., a radio channel), output the signals to the processor 730, and transmit signals output from the processor 730 via a radio channel.

Further, the transceiver 710 may receive the communication signal and output the communication signal to the processor and transmit the signal output from the processor to the UE or network device through the wired/wireless network.

The memory 720 may store programs and data necessary for the operation of the network device. Further, the memory 720 may store control information or data that is included in the signal obtained by the network device. The memory 720 may include a storage medium, such as ROM, RAM, hard disk, CD-ROM, and DVD, or a combination of storage media.

The processor 730 may control a series of processes for the network entity to be able to operate according to the above-described embodiments. The processor 730 may include at least one processor. The methods according to the embodiments described in the specification or claims of the present disclosure may be implemented in hardware, software, or a combination of hardware and software.

When implemented in software, there may be provided a computer readable storage medium storing one or more programs (software modules). One or more programs stored in the computer readable storage medium are configured to be executed by one or more processors in an electronic device. One or more programs include instructions that enable the electronic device to execute methods according to the embodiments described in the specification or claims of the present disclosure.

Although specific embodiments of the present disclosure have been described above, various changes may be made thereto without departing from the scope of the present disclosure. Thus, the scope of the present disclosure should not be limited to the above-described embodiments and should rather be defined by the following claims and equivalents thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. A method by a user equipment (UE) in a wireless communication system, the method comprising:
transmitting, to an access and mobility management function (AMF), a registration request message including a request slice and a per-cell slice service area (CSSA) support indicator; and
receiving, from the AMF, a registration accept message including service area information per-allowed slice for the UE based on the request slice and the per-cell slice service area support indicator,
wherein the request slice comprises a requested network slice selection assistance information (NSSAI) and the service area information per-allowed slice comprises a slice area per allowed NSSAI.

2. The method of claim 1, wherein the service area information per-allowed slice includes at least one of identifier information for at least one cell or identifier information for at least one tracking area (TA).

3. The method of claim 1, further comprising:
transmitting, to the AMF, a request message for requesting an allowed slice and an allowed slice area when the UE moves outside of a service area for the allowed slice.

4. The method of claim 3, further comprising:
receiving, from the AMF, a response message including information for the allowed slice area and the allowed slice requested in the request message.

5. A method by an access and mobility management function (AMF) in a wireless communication system, the method comprising:
receiving, from a user equipment (UE), a registration request message including a request slice and a per-cell slice service area (CSSA) support indicator; and
transmitting, to the UE, a registration accept message including service area information per-allowed slice for the UE based on the request slice and the per-cell slice service area support indicator,
wherein the request slice comprises a requested network slice selection assistance information (NSSAI) and the service area information per-allowed slice comprises a slice area per allowed NSSAI.

6. The method of claim 5, wherein the service area information per-allowed slice includes at least one of identifier information for at least one cell or identifier information for at least one tracking area (TA).

7. The method of claim 5, further comprising:
receiving, from the UE, a request message for requesting an allowed slice and an allowed slice area when the UE moves outside of a service area for the allowed slice.

8. The method of claim 7, further comprising:
Transmitting, to the UE, a response message including information for the allowed slice area and the allowed slice requested in the request message.

9. A user equipment (UE) in a wireless communication system, comprising:
a transceiver; and
a controller coupled with the transceiver and configured to control the transceiver to:
transmit, to an access and mobility management function (AMF), a registration request message including a request slice and a per-cell slice service area (CSSA) support indicator, and
receive, from the AMF, a registration accept message including service area information per-allowed slice for the UE based on the request slice and the per-cell slice service area support indicator,
wherein the request slice comprises a requested network slice selection assistance information (NSSAI) and the service area information per-allowed slice comprises a slice area per allowed NSSAI.

10. The UE of claim 9, wherein the service area information per-allowed slice includes at least one of identifier information for at least one cell or identifier information about at least one tracking area (TA).

11. The UE of claim 9, wherein the controller is further configured to transmit, to the AMF, a request message for requesting an allowed slice and an allowed slice area when the UE moves outside of a service area for the allowed slice.

12. The UE of claim 11, wherein the controller is further configured to receive, from the AMF, a response message including information for the allowed slice area and the allowed slice requested in the request message.

13. An access and mobility management function (AMF) in a wireless communication system, comprising:
a transceiver; and
a controller coupled with the transceiver and configured to control the transceiver to:
receive, from a user equipment (UE), a registration request message including a request slice and a per-cell slice service area (CSSA) support indicator, and
transmit, to the UE, a registration accept message including service area information per-allowed slice for the UE based on the request slice and the per-cell slice service area support indicator,
wherein the request slice comprises a requested network slice selection assistance information (NSSAI) and the service area information per-allowed slice comprises a slice area per allowed NSSAI.

14. The AMF of claim 13, wherein the service area information per-allowed slice includes at least one of identifier information for at least one cell or identifier information about at least one tracking area (TA).

15. The AMF of claim 13, wherein the controller is further configured to receive, from the UE, a request message for requesting an allowed slice and an allowed slice area when the UE moves outside of a service area for the allowed slice.

16. The AMF of claim 15, wherein the controller is further configured to control to transmit, to the UE, a response message including information for the allowed slice area and the allowed slice requested in the request message.
